(19) United States
(12) Patent Application Publication
(10) Pub. No.: US 2007/0012788 A1
(43) Pub. Date: Jan. 18, 2007

(54) Manufacturing process for encapsulation and cutting memory cards

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignees: Chien-Yuan Chen; Power Digital Card Co., Ltd.

(21) Appl. No.: 11/181,741

(22) Filed: Jul. 15, 2005

(51) Int. Cl. G06K 19/06

(52) U.S. Cl. 235/492

(57) ABSTRACT

A manufacturing process for encapsulation and cutting memory cards, embodying a full-wafer circuit board substrate, whereon is distributed a plurality of sets of a number of chip modules assembled from passive component members, flash memory modules and control chips. A mold is then used to carry out full-wafer compression molding to seal the chip modules and passive component members onto the circuit board substrate, thereby forming a plurality of sets of memory cards having complete electric functionality. Grooves are formed between neighboring memory cards when carrying out the compression molding process, which enable direct chamfering of edges and corners of each of the memory cards after cutting, thereby eliminating the need for further finishing.

### BACKGROUND OF THE INVENTION

(a) Field of the Invention

The present invention relates to memory cards, and more particularly to a memory card that provides for a computer or computer peripheral device to access data stored therein and a process for manufacturing memory cards.

(b) Description of the Prior Art

Because of the innovative advancement in current technologies, development of light, slim and small technological products have gradually become the mainstream of information products, and miniaturization of storage media used as digital peripheral products has followed likewise.

Media used for storing data and allowing access thereto is currently fabricated from flash memory, which has characteristics including a small drive device, light weight, low voltage operation, low electricity consumption, high reliability and high-speed access. Moreover, because flash memory is a non-volatile memory, it is able to directly change data through an electrical current (such as DRAM (dynamic random access memory)), and the data is retained after the power supply is cut off (such as ROM (read only memory)). Furthermore, flash memory has advantages including large storage capacity, fast read and write, silent operation and power saving, shock-proof, damp-proof, and so on, and thus has widespread application in built-in systems, portable-type information products and consumer electronic products, and is gradually becoming a mainstream product in the consumer electronics market. Electronic film and recording products such as digital cameras, digital movie cameras, PDAs (personal digital assistants), and so on, are major products having a demand for flash memory.

The increasing competitiveness among the many different memory card standards is fueled by the trend for design miniaturization; however, cost of producing the memory cards is still the major consideration. Hence, minimizing the manufacturing process and working procedure not only increases productivity, but also simultaneously reduces the manufacturing cost.

A conventional manufacturing method for a memory card involves distributing a plurality of sets of a number of chip modules assembled from passive component members, flash memory modules and control chips at preset positions on a circuit board substrate formed from a plurality of circuit boards. A mold is then used to carry out full-wafer compression molding or glue dotting, glue printing, thereby sealing the chips and the passive component members and forming a plurality of sets of electric circuit blocks having complete electric functionality. A plurality of sets of individual units (memory cards) having complete electric functionality are obtained after appropriately cutting the plurality of sets of electric circuit blocks.

The aforementioned individual memory cards are obtained by laser cutting a resin sealing compound layer, and the edges of the memory cards undergo further finishing in order to form chamfers or R corners after cutting is completed, which smoothes the edges of the memory cards to prevent scratching electronic products when inserting therein. However, such finishing must be carried out multiple times, which is not only time consuming, but also increases manufacturing cost.

In light of the aforementioned drawbacks of conventional methods for fabricating memory cards, the inventor of the present invention aggressively continued to make incessant improvements before ultimately designing a new improved manufacturing process for encapsulation and cutting memory cards of the present invention.

### SUMMARY OF THE INVENTION

Accordingly, a primary objective of the present invention is to eliminate the need to carry out secondary processing to provide peripheral edges of the memory card with chamfered edges after the memory cards have been formed by cutting a circuit board substrate.

Another objective of the present invention is in locating points of the circuit board substrate, which are localized to small areas, thereby enabling more precise cutting of each of the memory cards.

Yet another objective of the present invention is in the cutting of each of the memory card circuit boards on the circuit board substrate, which is realized by a one-time punching process, and then cutting of straight line edges and curved edges of two edges or more than two edges is carried out by laser cutting, thereby reducing manufacturing cost.

In order to achieve the aforementioned objective, a manufacturing process for encapsulation and cutting memory cards of the present invention first pre-punches exterior contours of a plurality of memory cards on a circuit board substrate, and a plurality of locating holes are defined at each corner of the circuit board substrate as well as at sides of the memory cards. A mold is then used to carry out compression molding of the entire circuit board substrate, thereby enabling a resin sealing compound layer to seal a distributed plurality of sets of a number of chip modules assembled from passive component members, flash memory modules and control chips onto the circuit board substrate, thus forming a plurality of circuit blocks having complete electric functionality. Grooves are formed in the sealing compound layer along perimeter edges of each of the circuit blocks during the compression molding process. Inner shape of each of the grooves can be defined according to requirements of different types of memory cards and appropriately changed to form an arc-shape, a V-shape, and so on. Finally, curved ledges of the circuit blocks are laser cut to enable direct chamfering of the memory cards obtained.

According to the aforementioned structure, the manufacturing process for encapsulation and cutting memory cards of the present invention is simply and accurate, and price of the memory card produced is reduced. Moreover, the manufacturing process design is universally applicable to producing the majority of current memory card types, thereby reducing the working process and saving on manufacturing cost, which is in keeping with the present tendency for the electronic consumer market to operate on small profits.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic elevational view of a preferred embodiment according to the present invention.

FIG. 2 shows a cross-sectional view of the preferred embodiment according to the present invention.

FIG. 3 shows a schematic elevational view from another perspective according to the present invention.

FIG. 4-FIG. 6 show schematic views of a manufacturing process of the preferred embodiment according to the present invention.

FIG. 7 shows a schematic cross-sectional view of FIG. 6.

### DETAILED DESCRIPTION OF THE PREFERRED EMBODIMENTS

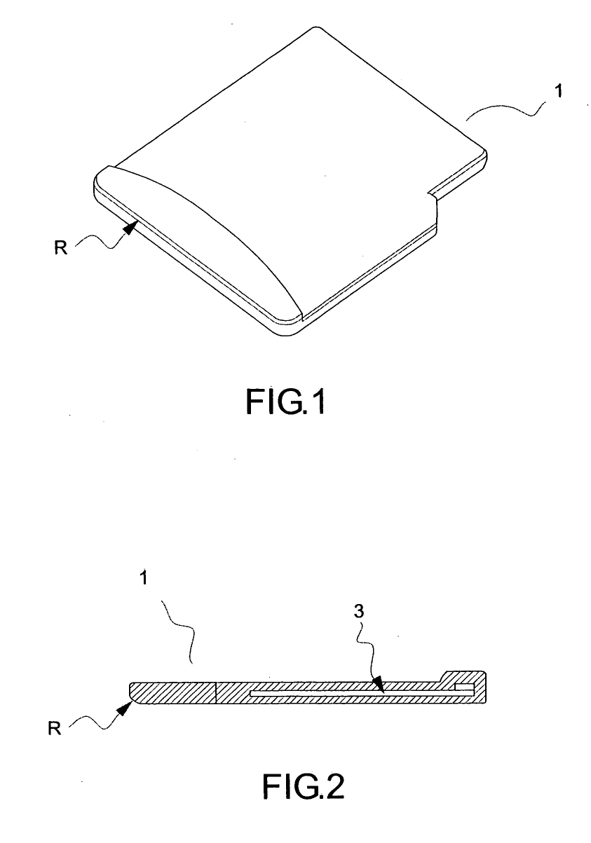

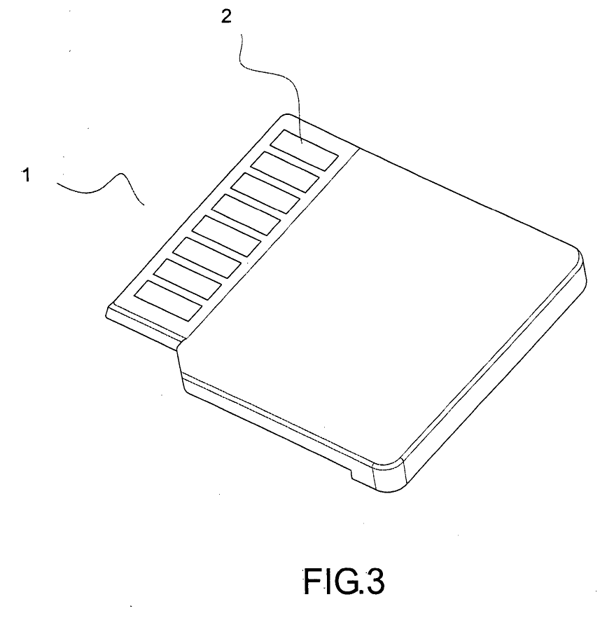

Referring to FIGS. 1 and 2, which show a schematic elevational view and a cross-sectional view of a preferred embodiment of the present invention respectively. Referring also to the other figures, structure of a memory card of the present invention can be seen to comprise a full-wafer circuit board substrate 10, whereon is distributed a plurality of sets of a number of chip modules assembled from passive component members, flash memory modules and control chips at preset positions. A mold is then used to carry out full-wafer compression molding using a resin sealing compound layer 20 to seal components including the chips, passive component members, and so on, and electric conducting metallic members 2 pre-embedded to provide electrical connection with an electronic product, thereby forming a plurality of sets of circuit blocks provided with complete electric functionality. Characteristics of a manufacturing process for encapsulation and cutting memory cards of the present invention is described hereinafter:

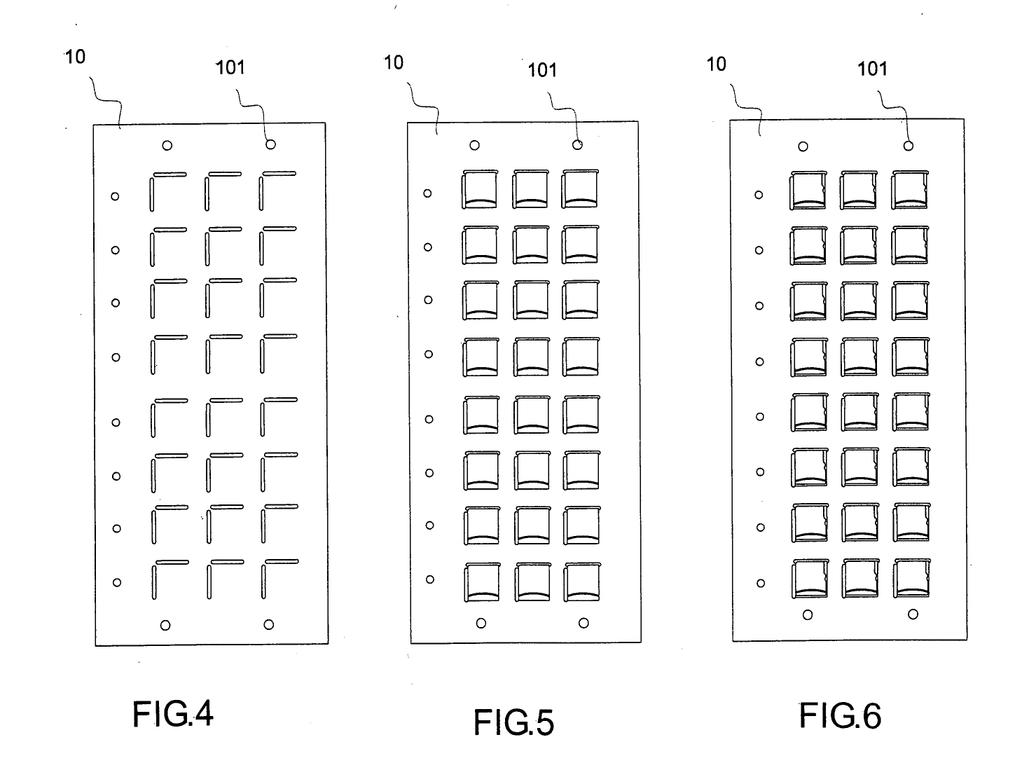

First, exterior contours of a plurality of memory cards 1 are pre-punched on the circuit board substrate 10 (see FIG. 4), and a plurality of locating holes 101 are defined in perimeter edges of the circuit board substrate 10 to match the number of memory cards 1, which are used to increase precision in cutting and encapsulation of each of the memory cards 1 on the circuit board substrate 10, and prevent the occurrence of turning up or skewing when forming the exterior contours of each of the memory cards 1 on the circuit board substrate 10.

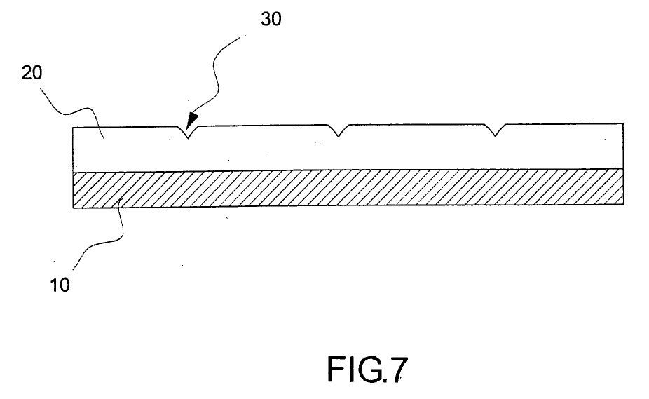

A plurality of passive components, flash memory modules and control chips are then distributed on each of the circuit blocks, and the mold is used to carry out full-wafer compression molding or glue dotting, glue printing of the circuit board substrate 10 to seal the chips and the passive components thereon, thereby forming the plurality of sets of circuit blocks having complete electric functionality (see FIG. 5). Grooves 30 are defined along cutting areas between each of the circuit blocks, and which are directly formed on the resin sealing compound layer 20 when carrying out the compression molding process. Inner shape of each of the grooves 30 can be defined according to type, standard and dimensions of the memory card 1 to be produced and appropriately changed to form an arc-shape, V-shape, and so on. The curved edges of the circuit blocks are laser cut to form complete exterior contours of the memory cards 1 (see FIG. 6). Because the exterior contour of two edges or more than two edges of each of the memory cards 1 is finished in advance by the relatively inexpensive manufacturing process of punching, while the relatively expensive manufacturing process of laser cutting is used to finalize cutting of the remaining portion of curved edges, thus, manufacturing cost is effectively reduced. Moreover, the grooves 30 defined around each of the circuit blocks 30 (see FIG. 7) enable cutting corner edges of the memory card 1 obtained from each of the circuit blocks to directly form R edges (see FIG. 1) thereon, thereby further omitting the manufacturing process of prior art that necessitates finishing the edges to form chamfers or R edges after cutting.

The present invention achieves fabricating a memory card by the above disclosed art means using a manufacturing process that is simple and quick, which not only eliminates many processing steps, but is also able to effectively reduce manufacturing time and cost. Hence, the manufacturing process for encapsulation and cutting memory cards of the present invention has substantial advantages over current memory card manufacturing processes, which use a mold in addition to sealing encapsulation and cutting.

In conclusion, elements of the structure as disclosed in the present invention are lacking in prior art, and have assuredly achieved effectiveness of anticipated advancement. Moreover, provides practicality for manufacturing industries, and fully complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A manufacturing process for encapsulation and cutting memory cards, comprising a plurality of sets of chip modules distributed on a full wafer circuit board substrate, and uses a mold to carry out full-wafer compression molding and encapsulation to seal the chip modules onto the circuit board substrate, thereby forming a plurality of sets of memory cards having complete electric functionality, and is characterize din that:
grooves are formed along cutting areas between each of the memory cards when carrying out the compression molding process, which enable direct chamfering of edges and corners of each of the memory cards after cutting, thereby eliminating the need for further finishing;
circuit boards of each of the memory cards on the circuit board substrate are cut by a one-time punching process, and then cutting of straight line edges and curved edges of two edges or more than two edges is carried out by laser cutting.

2. The manufacturing process for encapsulation and cutting memory cards according to claim 1, comprising a plurality of locating holes are defined in perimeter edges of the circuit board substrate.

3. The manufacturing process for encapsulation and cutting memory cards according to claim 1, comprising the grooves are concave arc-shaped.

4. The manufacturing process for encapsulation and cutting memory cards according to claim 1, comprising the grooves are V-shaped.
